(19) United States
(12) Patent Application Publication
(10) Pub. No.: US 2014/0164192 A1
(43) Pub. Date: Jun. 12, 2014

(54) FRANCHISE ROYALTY AND ADVERTISING FEE COLLECTION

(71) Applicant: DAVO TECHNOLOGIES LLC, Montclair, NJ (US)

(72) Inventors: Owen H. Brown, Montclair, NJ (US); David N. Joseph, Bowdoinham, ME (US)

(73) Assignee: DAVO TECHNOLOGIES LLC, Montclair, NJ (US)

(21) Appl. No.: 13/708,906

(22) Filed: Dec. 7, 2012

(51) Int. Cl. G06Q 40/00

(52) U.S. Cl. CPC G06Q 40/10
USPC 705/30

(57) ABSTRACT

A computer-implemented method is provided for segregating funds associated with sales or transactions of a franchisee to pay royalties and/or advertising fees to a franchisor. The method may include determining a sales amount corresponding to one or more transactions of a seller associated with a closeout period, determining a transfer amount based on the sales amount and at least one franchise rate, and transmitting an instruction to a financial institution directing the financial institution to debit the transfer amount from an account associated with the franchisee and to credit a second account with the transfer amount when the sales amount equals or exceeds the transfer amount.

### FIELD OF THE INVENTION

The present application relates to a computer-implemented method and system for segregating funds or for paying out funds associated with at least one sale of a seller, e.g., a merchant, such as for the payment of a franchise fee owed by a seller to a franchisor, or other obligation of a seller.

### BACKGROUND OF THE INVENTION

Computers facilitate with high speed and accuracy a vast myriad of commercial transactions, including credit card transactions. Franchising is common among businesses. A franchisor, who may be a developer or owner of a particular business model, such as for a retail store, restaurant, fast food restaurant, drug store, rental car agency, temporary employment agency, beauty salon, or gasoline or automotive service station, for example, can give a franchisee the right to operate according to the business model in exchange for a franchise fee. Typically, the franchise fee is calculated as a percentage of the franchisee's gross receipts, and may be a single amount. Alternatively, the franchise fee may comprise a first amount as a royalty owed by the franchisee for the right to operate the business, and a second amount owed by the franchisee for advertising conducted by the franchisor.

There is a need for an improved method by which a seller, e.g., a franchisee, may transfer amounts based on the sales of the seller to pay franchise fees to a franchisor such as for royalties in conducting the business and for advertising provided by the franchisor. The methods disclosed herein can facilitate collection, escrowing and payment to be performed by one or more third parties, e.g., with a financial or other institution possibly holding escrow funds, so that seller's direct participation may be limited to a passive role.

### BRIEF SUMMARY OF THE INVENTION

A computer-implemented method according to an aspect of the invention is provided which can include determining a sales amount corresponding to one or more transactions of a franchisee associated with a closeout period. A transfer amount can be determined based on the sales amount and at least one franchise rate applicable to the one or more transactions. An instruction can be transmitted to an electronic funds processor (EFP) directing the EFP to credit an account with the transfer amount when the sales amount equals or exceeds the transfer amount.

In accordance with one or more examples, the determining of the transfer amount can include determining a first sales amount associated with one or more non-bank card transactions during the closeout period, and determining a second sales amount associated with one or more bank card transactions during the closeout period. In one example, the transmitting of the instruction can include transmitting an instruction to the EFP directing the EFP to credit the account with the transfer amount on condition that the second sales amount at least equals the transfer amount.

In accordance with one or more examples, the determining of a sales amount may include determining first and second sales amounts using information associated with the closeout period transmitted from at least one sales registry device.

In accordance with one or more examples, the instruction may direct that an account associated with the franchisor be the account directed to be credited.

In accordance with one or more examples, the account can be an escrow account, and the method may further include transmitting an instruction to an institution associated with the escrow account to direct the institution to credit an account associated with a franchisor with a second amount. In one or more examples, the second amount may equal or exceed the transfer amount.

In accordance with one or more examples, the method may further include determining an interval sales amount based on a sum of sales amounts corresponding to each of a plurality of closeout periods within a reporting interval. The determining may be performed using information representing the sales amount in each corresponding closeout period, and may include determining a franchisee interval amount based on the interval sales amount and the franchise rate, determining a sum of the transfer amounts credited to the account based on the reporting interval; and determining whether an amount is owed by the franchisee based on comparing the franchisee interval amount with the sum of the transfer amounts corresponding to each of the plurality of closeout periods.

### BRIEF DESCRIPTION OF THE SEVERAL VIEWS OF THE DRAWINGS

A more complete understanding of the invention may be obtained by reading the following description of specific illustrative embodiments of the invention in conjunction with the appended drawing in which:

FIG. 1 is a schematic diagram illustrating a method for obtaining authorization for a bank card sale;

FIG. 2 is a schematic diagram illustrating a method according to an embodiment of the invention;

FIG. 3 is a block diagram illustrating a computer system which can be used in a method according to an embodiment of the invention;

FIG. 4 is a schematic diagram illustrating a method according to an embodiment of the invention;

FIG. 5 is a schematic diagram illustrating a method according to an embodiment of the invention;

FIGS. 6A-6C illustrate various embodiments of the invention in examples with bank card sales, and with non-bank card sales; and

FIG. 7 is a schematic diagram illustrating a method according to an embodiment of the invention.

### DETAILED DESCRIPTION OF THE INVENTION

The following detailed description includes a description of the best modes of the invention presently contemplated. Such description is not intended to be understood in a limiting sense, but to be an example of the invention presented solely for illustration thereof, and by reference to which in connection with the following description and the accompanying drawings one skilled in the art may be advised of the advantages and construction of the invention.

Embodiments of the invention described herein may be utilized for the collection of royalties or other running payments due from one party to another party under an agreement based on the sales of that party. Frequent reference is made herein to a franchisee owing royalties to a franchisor. Strictly speaking, “franchisee” and “franchisor” mean parties which have an existing franchise agreement between them which obligates the franchisee to pay royalties to the franchisor in exchange for certain benefits, such as use of a business model and trademark, for example. However, the concepts used herein can also apply to parties who are engaged in a similar business relationship, e.g., a retail association or cooperative, growers cooperative, nonprofit organization association, in which a running fee is assessed on sales or volume of business conducted for payment to a body managing the association or cooperative on behalf of its members. In such case, the members stand in a similar position to franchisees and the managing entity of such association or cooperative stands in a similar position to the franchisor, although the relationship is not one of franchisee and franchisor. The principles of collecting running fees based on sales or business volume for payment to another are similar, and the following description applies to collection of fees in such relationships, whether or not an actual franchisee-franchisor relationship exists.

Frequent reference is made herein to transactions involving the use of “bank cards”, as well as “non-bank card” transactions which do not involve the use of bank cards. As used herein, a “bank card” is a “credit card” or a “debit card”. Further, as used herein, a “credit card” is a card that represents a line of credit extended by an institution, e.g., a bank or financial institution or other business that lends, which card a customer can use to pay for purchases from a seller, most typically after obtaining credit authorization for the transaction from the lender at the time of the transaction. The credit card in some cases may be issued by the seller rather than by a bank or other financial institution, and is nevertheless included herein within the definition of “bank card”. Further, as used herein, a “debit card” is a card linked to a financial or other depository institution to facilitate customer withdrawals primarily from a deposit account, or investment account, for example, although the customer may be permitted to draw upon other resources such as a line of credit when the balance available in the account is insufficient for the withdrawal.

By contrast, as used herein, “non-bank card” transactions refer to transactions for which payment is made in cash or in one or more of a variety of financial instruments such as personal check, bank check, traveler's check, pre-paid card, e-wallet, gift card as defined below, or other such financial instrument which is not a “bank card” as defined herein.

As also referred to herein, “card” transactions and “card” sales may refer to transactions using bank cards, or other forms of payment for processing electronically, such as may be processed by an electronic funds processor as described herein. Reference is also made herein to a “merchant” and a “seller”. The “franchisee” in the description below is a seller, and in many cases may also be a merchant. As used herein, a “seller” is anyone who sells an item, which may be goods, services or a rental or lease, for example, and for whom a portion of funds associated with at least one sale can be segregated and/or paid to a third party in accordance with the embodiments of the invention described herein. As used herein, a “merchant” is a “seller” as defined herein who, in particular, is authorized to receive bank card payments from customers directly through an Acquirer. Summarizing, all merchants are sellers; however, not every seller is a merchant. As used herein, an Acquirer is an institution, most typically a financial institution such as a bank, which facilitates the authorization of and entry of bank card transactions, and facilitates the associated transfers of funds between institutions such as bank card issuers and sellers, e.g., merchants. An Acquirer often is a separate institution from either the seller or the bank card issuer. However, in the case of AMEX or Discover, the Acquirer can be incorporated in the same institution as the bank card issuer. In another example, such as when the seller itself issues bank cards, the Acquirer may be incorporated in the same institution as the seller.

At least some of the embodiments herein can be utilized to make funds available from the proceeds of transactions of a franchisee, whether or not the franchisee has merchant status, and without considering whether there is a particular number, frequency or volume of sales. Accordingly, particular embodiments of the invention may apply to a small or online franchisee who is a seller of goods or services with relatively small or infrequent sales. The franchisee in some cases may rely upon payment intermediary services such as PayPal (a service provided by an entity owned by Ebay Corporation) and Square (a service of Square, Inc.) and the like, which perform and/or facilitate electronic processing of funds, if the franchisee cannot or does not wish to meet credit and financial requirements for merchant status in bank card networks, e.g., Visa/MC, AMEX, or Discover. Currently, EFPs are commonly used in the industry for managing bank card transactions between merchants and banks. This function often includes the collection of associated service fees by the EFP on behalf of the bank card provider (for example, Visa and MasterCard) for electronic funds transfer (EFT) to a merchant account. Alternatively, in the case of American Express (AMEX) and Discover, service fees are first deducted before net sales (less service fees) are EFT deposited by AMEX and Discover in the merchant account.

In a particular example, the bank card can incorporate an “EMV” chip, EMV being an acronym for a standard adopted by Europay, Mastercard and Visa, and which are now in use in Europe and may soon be in use in the United States as well. An EMV chip card enables its holder to obtain authorization for a transaction using information recorded on the bank card itself; specifically, as recorded on an integrated circuit (“IC”) chip incorporated in the bank card. An EMV chip card in this way allows a transaction to be authorized for payment via the EMV chip card even when the merchant is unable to electronically transmit an authorization request for the transaction to an Acquirer. Information about the transaction that is collected by the merchant can then be forwarded at some later time to the Acquirer, e.g., at the end of a closeout period, and the Acquirer can then credit an escrow account and the merchant account with the applicable portions of the transaction proceeds. Even in systems which require electronic authorizations to be provided from the card issuer, EMV chip cards can also be used to verify the authenticity of a bank card, because the security features in such cards are more difficult to defeat than traditional bank cards that record information only on magnetic stripes. Specifically, one frequent way that transactions using EMV chip cards are approved involves the customer entering a personal identification number (PIN) when presenting the EMV chip card to the seller, wherein the transaction is only approved when the PIN matches the information stored in the IC chip on the card.

In one example, sales or other transactions made through a payment intermediary service such as PayPal or Square can be performed using an EFP to obtain payment authorization and process the payment, with the processing of fees or percentages from amounts handled by the EFP and the payment intermediary.

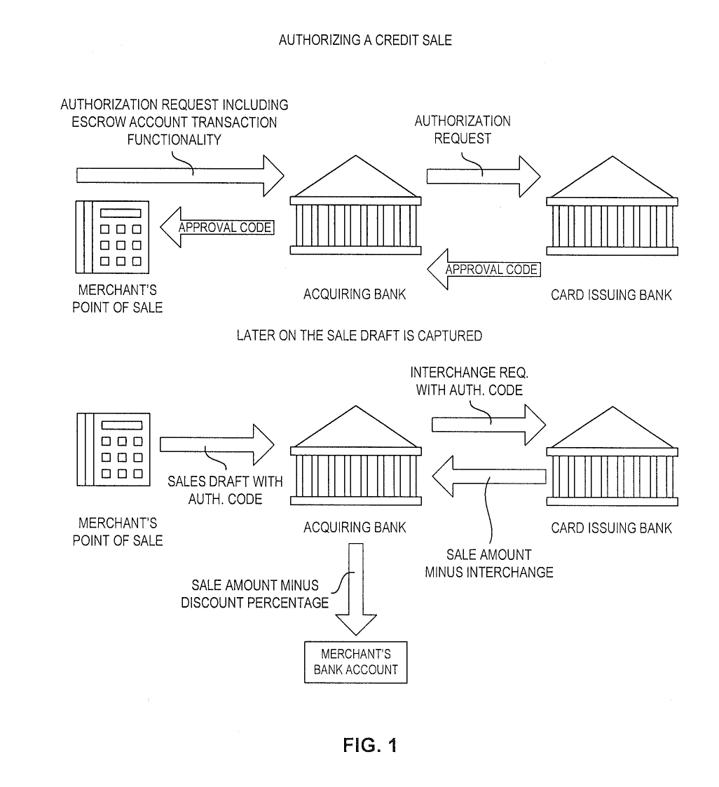

Similarly, the methods described herein may be applied to funds received by the franchisee in the form of instruments such as personal checks, bank checks, or money orders. In this case, the EFP can be an element of an electronic check processing service which processes checks and money orders received by the franchisee, which in some cases can be done by capturing an image of the check or money order on a point of sale (POS) terminal, or other sales registry device as described below, and transmitting the captured image to the check processing service for payment. An example of a currently practiced method of authorizing a bank card purchase and processing the payment associated with the purchase is illustrated in FIG. 1. As shown therein, authorization for a bank card sale is requested from a sales registry device, e.g., POS device, of a merchant, which is then transmitted to an Acquirer, labeled in FIG. 1 as “acquiring bank”, and from there to the card issuing bank for the customer's bank card. If authorized, an approval code is transmitted from the card issuing bank back to the Acquirer, and approval is communicated from the Acquirer to the sales registry device of the merchant. Later on, the sales draft is captured. At the end of a day, or at the end of a predetermined period, which can be more or less than a day, the card issuing bank settles an account with the Acquirer for transactions associated with the predetermined period. The Acquirer can credit the franchisee's bank account with the amount of the sale minus a percentage which can be charged based on the type of bank card used, e.g., Visa, MasterCard, AMEX or other card.

In another example, a franchisee can accept value represented by a gift card in exchange for an item sold by the seller. Such gift card, which often is issued by a franchisor or corporate affiliate of the franchisor, may represent value, similar to store credit, which is promised to the customer and which the customer can use to make purchases from a franchisee of the issuer or from the issuer itself under certain authorized conditions. A proposed transaction involving such gift card can be checked for approval, for example, by swiping the gift card at a bank card terminal, which prompts a database associated with the gift card to be checked to determine whether the gift card has sufficient value for the transaction to be approved. The methods and systems according to the embodiments herein are not limited to the processing of transactions and payments using traditional POS terminals, which typically have very specific hardware and are typically found at fixed locations in a store or other establishment operated by the merchant.

Traditionally, POS terminals have relied on hard-wired network communications between them and a management interface through which communications can be sent and received for authorizing bank card payments from a customer and the like. Rather, a device on which sales and payments, e.g., bank card payments are processed, can be a “sales registry device” which can be implemented in a number of different ways. In one example, the sales registry device can have a wireless communication interface such that the sales registry device is configured to communicate information for authorization of and processing of transactions and payments over the wireless communication interface. In another example, the sales registry device may include or utilize a wireless communication interface such as can be provided on a portable computing platform that is configured to operate via battery power, such as commonly used in authorizing and processing payments and transactions for some retail electronic stores, rental car agencies and in restaurants, particularly in Europe. For example, the portable computing platform may be configured to process transaction information and payments on battery power for a period of time of one hour or more. In a particular example, the sales registry device can be implemented using a general purpose computer (a microcomputer such as a desktop computer, laptop computer, or otherwise) having software instructions stored in a storage accessible to the microcomputer which can be executed by one or more processors of the computer to authorize and process a transaction.

In one example, the sales registry device can have an open industry platform that is configured to permit user-reconfiguration by installation of program software which may be available from various vendors. In one example, the sales registry device can be implemented using a mobile computing device having a more specialized function such as a tablet computer, or a smartphone such as devices that have cellular or other telephone function. The mobile computing device can have an open industry platform which is user-reconfigurable by installation of program software which may be available from various vendors. Without limitation, examples of such mobile computing devices include tablet computers such as iPad™ (Apple Computer Corp.), other tablet computers, and smartphones such as iPhone™ (Apple Computer Corp.) Android™-enabled devices (Google) and Blackberry™ (Research In Motion) devices. In a particular example, payment authorization and processing can be facilitated using a mobile card reader that can be electrically connected, or otherwise linked or paired with the mobile computing device. In one example, the mobile computing device may be capable of sustaining operation on battery power for periods of one to several hours or more while processing sales transactions and payments therefor.

In accordance with an embodiment of the present invention, a method is disclosed in which a third party (e.g., the EFP) may collect funds to be paid to a franchisor based on a royalty or advertising payment owed by a franchisee to the franchisor. The payment amount typically is calculated as a percentage of the franchisee's gross sales. Initially, information entered at a bank card terminal (for example, entry of the bank card number by swiping, and purchase amount and card expiration by keypad entry) is received by the EFP and forwarded to a bank card issuer for authorization. Authorization is provided (for example, as indicated by an issuer-assigned confirmation number) and forwarded by the card issuer via the EFP to the merchant for storage in the bank card terminal. At the end of a transaction period also referred to as “closeout period” herein (for example, at the end of each day), the franchisee merchant may “close out” bank card sales at a POS terminal or bank card terminal associated therewith. As part of the closeout process, the EFP can make one or more payments to the merchant's account based on the sales of that closeout period. Once the EFP has obtained funds from the bank card issuers for one or more transactions in the closeout period, an amount owed by the franchisee as a franchise fee is debited from gross sales, and the net funds are credited via EFT to the merchant's account or to another provider (such as American Express) for crediting to the franchisor's account.

Alternatively, as will be further described below, the debited portion of sales may instead be credited to an escrow account where it can be held until payment is made to the franchisor. Once deposited in an escrow account, funds may be transferred at defined intervals to a franchisor (or other owed parties) by the escrow agent in order to meet the seller's payment obligations to the franchisor. The escrow agent may be compensated for this service by retaining interest earned on funds (“float”) in the account in between payment periods.

In one embodiment, the method can be implemented by transmitting an instruction to the EFP to cause the EFP to credit an escrow account with an escrow amount determined based on a sales amount of the seller and an applicable franchise rate. For example, a computer system according to an embodiment of the invention which oversees the escrowing of funds can generate and transmit an instruction to the EFP to credit the escrow account based on the transactions of the seller. The EFP can then act on the instruction, i.e., credit the escrow account with the amount stated or determined in accordance with the instruction. In one example, the EFP can use the same type of equipment, e.g., program software and/or hardware that the EFP otherwise uses, to deduct the bank card provider fees charged to the seller for account transactions. Bank card providers, e.g., Visa/MC, AMEX and Discover, charge fixed or variable fees which often are charged as a percentage of the value of a transaction. Frequently, the fees are charged to each seller or merchant for each batch of bank card transactions corresponding to a particular closeout period which can be one day or a period of time shorter or longer than one day.

An embodiment of the invention provides a method by which amounts based on a franchise royalty and/or advertising rate due on transactions between a franchisee seller and its customers can be debited by an EFP from bank card transactions, and paid to the franchisor, with little or no imposition of burden on the seller. In such embodiment, this method can be implemented by the EFP crediting an amount from the proceeds of one or more bank card transactions of the franchisee directly to an account of franchisor. This can be done because the EFP is already processing bank card transactions in order to credit the gross amount of a bank card transaction, less the bank provider's fees, to the seller's bank account.

A franchisee's receipts associated with non-bank card transactions (for example, payments made with physical currency, personal checks, bank checks, travelers checks, pre-paid cards, e-wallets, money orders, gift checks, gift certificates, gift cards such as described above, or other foreseeable items of monetary value) can also be accommodated by the method according to an embodiment of the invention. A number of approaches for making franchise payments accruing from any or all such transactions or for the payment of other obligations of the seller or for effecting a seller savings account are described in the following.

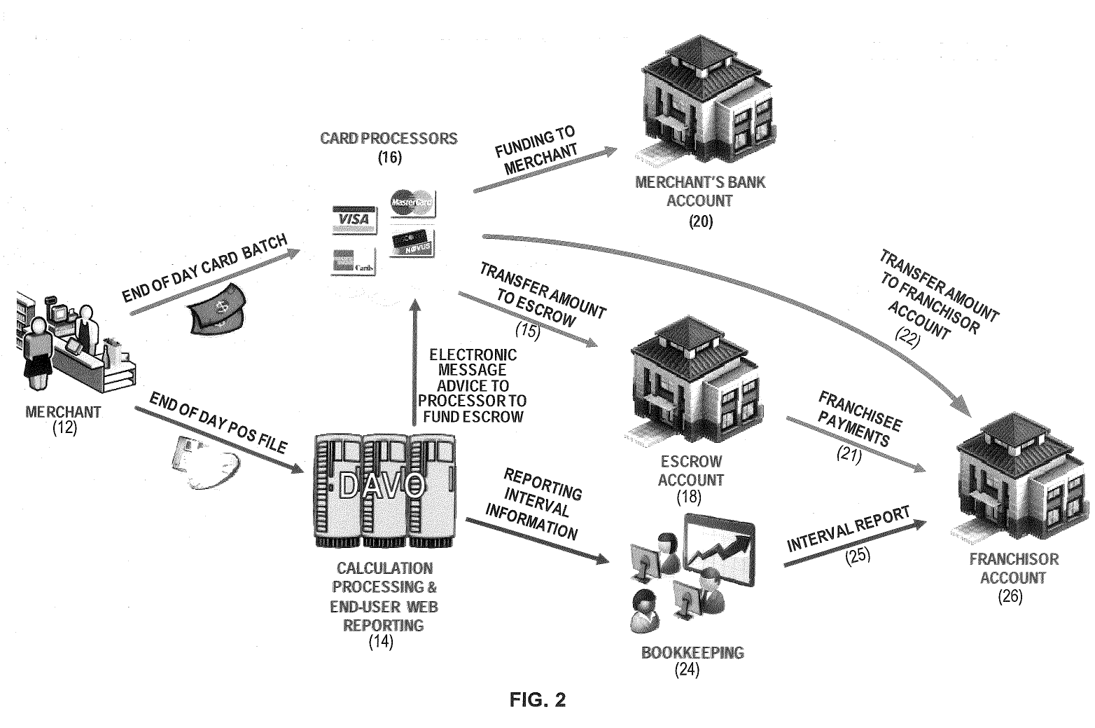

FIG. 2 illustrates a method of segregating or escrowing funds according to an embodiment of the invention. The different entities that handle the processing of funds are illustrated therein. As seen in FIG. 2, a franchisee merchant (12) operates one or more sales registry devices on which sales transactions and payments are handled, and on which payment authorization can be obtained, such as through use of a card reader, as described below.

In one example, the sales transactions of a franchisee-seller or merchant can be processed through one or more POS terminals for a closeout period such as a day. At the end of the closeout period after closing out the one or more POS terminals and sending out data regarding the transactions for the day, funds can be set aside for making franchise payments, or alternatively, paid directly to a franchisor based on data recording the amount of sales at the one or more POS terminals during the closeout period. As described further herein, the calculation of franchise fees and the directing of funds into escrow, or alternatively to be paid directly to the franchisor, can in one example be done automatically via a computer system managing the process which can transmit an instruction to an EFP or institution where the seller banks. Alternatively, in a particular example which can be referred to as “forced entry”, the franchisee-seller or merchant can select a particular amount of funds to be paid to the franchisor for the closeout period, and the computer system can then pay such amount to a franchisor without further intervention by the seller.

As further seen in FIG. 2, the transaction data associated with the closeout period can be forwarded from the POS terminal to a computer system (14). In one example, the sales transaction data can include Z-file data forwarded, e.g., “pushed” from or retrieved, e.g., “pulled” from a POS terminal of the merchant. The Z-file data can include, for example, data for the most recent closeout period which may indicate some or all of the following: Total Sales, and Returns as well as Merchant Identifying Information. Typically, the sales transaction data is forwarded to the computer system after the end of each closeout period, which may occur daily, and the sales transaction data may relate not only to bank card sales, but may also relate to non-bank card sales such as transactions for which payment is made by cash, check, or other source of funds. At the end of each closeout period transaction data relating to bank card transactions during the closeout period are also forwarded to the EFP, which is shown as “Card Processors” (16) in FIG. 2.

The computer system (14) receiving Z-file data from a POS terminal or other sales or transaction data from another type of sales registry terminal, can determine a sales amount which corresponds to one or more transactions of the seller associated with the closeout period. In one embodiment, the sales amount can be associated with a particular sales registry device or can be associated with a particular salesperson, whether or not the particular salesperson utilizes the same sales registry device during the closeout period.

The computer system (14) processes the received transaction data to determine a transfer amount to be paid to the franchisor based on a sales amount during the closeout period. In one example, the transfer amount can be an amount based on a franchise rate applicable to one or more transactions to which the transaction data relates. As further seen in FIG. 2, based on the one or more transactions in accordance with the transaction data, the computer system (14) can generate and cause an instruction, e.g., electronic message advice, to be transmitted to the EFP (16). The EFP can then use the transmitted instruction, e.g., electronic message advice, to credit, i.e., pay the transfer amount (22) to an account of a franchisor (26). In such case, an amount that remains from the sales of the franchisee after deducting the transfer amount can be credited to the merchant's, i.e., franchisee's, bank account (20), as indicated by the arrow “Funding to Merchant.”

In another example, the EFP may use the transmitted instruction to credit an escrow account (18) with the determined escrow amount, as indicated by “Transfer Amount to Escrow” (15) in FIG. 2. In addition, in such case, the EFP may credit a bank account of the merchant franchisee (20) with a portion of the sales amount of the one or more transactions, net of the determined escrow amount.

As further seen in FIG. 2, at some appropriate time interval, which may be determined as a reporting interval established by a franchisor or by agreement between the franchisor and franchisee, payments (21) can be made from the escrow account (18) to the franchisor (26). In one example, the payments may be only franchisee payments. However, in another example, the payments may include an extra payment for other obligations owed the franchisor or other party by the merchant or seller.

In a particular embodiment, the computer system (14) can transmit an instruction to an institution which manages the escrow account directing payment of a franchise royalty or other amount such as an advertising fee from the escrow account to a franchisor or other payee. In one example the computer system (14) may direct the institution to credit a payee, e.g., the franchisor, with an amount by transmitting an instruction to a second computer system associated with the institution, wherein the instruction may include information representative of an account of the payee and the payable amount to be paid to the franchisor or other payee. In one example, the amount paid to the payee this way can be for payment to the franchisor as a franchisee payment (2).

As seen in FIG. 2, from transaction data the computer system (14) may generate information concerning the volume of sales during a particular reporting interval and regarding the volume of transactions during the interval. The computer system may register a sales amount for the reporting interval using the accumulated transaction data that can be based upon the Z-file data for each of the closeout periods in the reporting interval. This information may include information which may be made available or provided to a bookkeeping or accounting service (24). In turn, the information can be used by the bookkeeping service to prepare and submit a report (25) to the franchisor (26). Alternatively, and in an appropriate case, the computer system itself may aid in the preparation of a report for the reporting interval, which can then be approved by the franchisee merchant prior to forwarding the same to the franchisor.

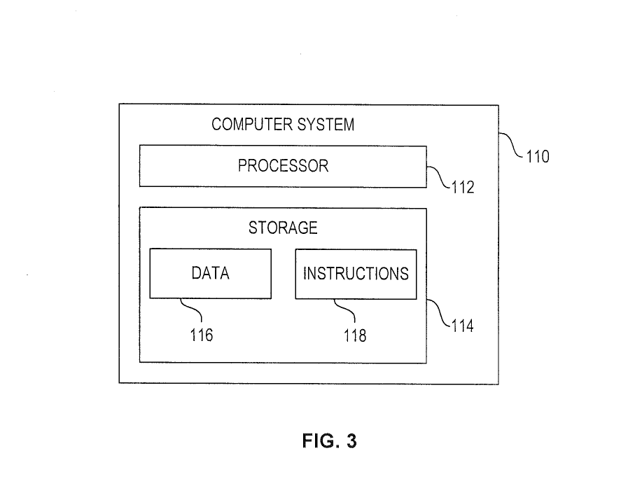

As seen in FIG. 3, an exemplary computer system which may be used to carry out a method according to an embodiment of the invention can include one or more computer or information processing systems 110, each of which may have a processor 112 comprising one or more microprocessors. The one or more computers 110 may each function as a server to serve or transmit data 116 and instructions 118 to other computers. As will be described further below, such computer 110 may exercise a control function to provide an instruction to another computer or EFP to direct that escrow funds be segregated and transferred to an escrow account.

The computer system 110 may comprise special purpose or general purpose computing equipment for carrying out a method of operation in accordance with the embodiment of the invention. Such computer system can control the segregation of escrow funds in the method by generating and transmitting an instruction directing an EFP or institution such as a bank to credit an escrow account based on the transaction of the seller. In particular examples, the computer system can be a computer system independent of a computer system associated with one or more sales registry devices or POS terminals (12, FIG. 2) of the seller, and independent of a computer system or network which implements the EFP (16, FIG. 2). Alternatively, the computer system can be associated with one or the other of a computer associated with one or more sales registry devices or POS terminals (12, FIG. 2), or a computer system or network which implements the EFP (16, FIG. 2).

Each such computer 110 typically has storage 114 available thereto for storing and retrieving information used by the processor 112 within the computer. For example, storage 114 may be used to store data and instructions which are executable by such processor. Storage 114 can include, for example, one or more of various magnetic, solid-state or optical drives, etc., for read-write access to data and instructions. The storage 114 can also include one or more various portable memory media which can be read-write type, read-only type or combination type (e.g., a type of medium designed to be written only once but read many times), which can be recorded or read by electrical, magnetic, or optical means. For example, the storage 114 can include an internal or external memory drive or miniature memory card, e.g., SD card or drive, a compact disc (“CD”) or CD-ROM, digital versatile disc (“DVD”), or magnetic tape media, etc., which are easily and readily interchangeable with other similar media, and on which data or instructions or both can be recorded, read and, in some cases, executed by the computer. The computer system 110 can be connected to additional storage (not shown), e.g., a mass storage device such as a hard-drive, tape-drive or solid-state drive, which can be locally connected thereto, or storage available over a network. The additional storage can in some cases house one or more repositories of data, e.g., databases. In a particular example, storage available to the computer system over a network can be “cloud-based storage.” Cloud-based storage can in some cases be sourced from multiple locations over a network. Cloud-based storage may also permit multiple copies of the same data to be stored at multiple different locations on a network for added security in case of events which impact availability of a particular computer system or the network in which that computer system resides.

Instructions 118 utilized by the computer 110 can be any instructions which are executable either directly by the processor, such as machine language instructions, or which can be rendered directly executable from any computer-readable language, such as from computer-readable and compilable code, or from interpretable code or from a combination of compilable and interpretable code. The data 116 can be handled, i.e., written to storage or retrieved therefrom or modified based on the execution of the instructions 118 by the processor 112.

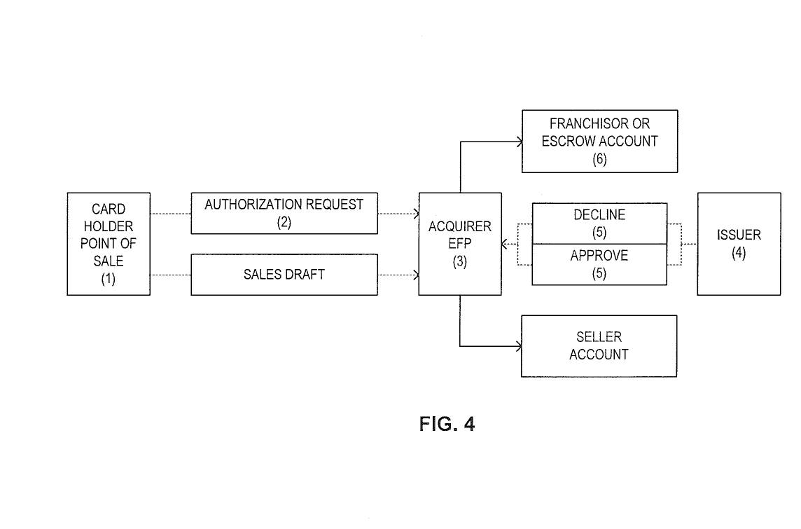

A schematic diagram illustrating another possible implementation of the method is provided in FIG. 4, which can involve the following operations: As seen at (1), the customer making a purchase presents a bank card to the seller, e.g., franchisee, which may be at a point of sale. At (2), the seller can use a sales registry device, e.g., an electronic terminal at a point of sale, or a smartphone, for example, or alternatively a telephone to request authorization to charge the customer bank card for the transaction. At (3) the Acquirer receives the authorization request and forwards it to the bank card issuer. In the case of Visa and MasterCard, the Acquirer can be an institution that is the same as, but is usually independent from the institution, e.g., financial institution or seller that issued the bank card. However, the functions performed by the Acquirer can be part of the same institution as the issuer, such as when the card is from AMEX or Discover. At (4), the issuer receives the authorization request and approves or declines the transaction, which status is then communicated back to the sales registry device or terminal at the seller, as indicated by the notations “Decline (5)” and “Approve (5)” in FIG. 4. When authorization of the transaction is received at the sales registry device, the customer and seller can proceed with the bank card transaction, at which time the customer may sign a sales draft or enter a personal identification number (“PIN”), for example, to complete the sale. Information about the completed bank card transaction can then be collected and forwarded from the sales registry device or POS terminal to the issuer via the EFP, a part of the Acquirer. In turn, based on the amount of one or more transactions within a closeout period of the seller, as will be described more fully below, as seen at (6) the EFP can be instructed to transfer a determined amount of funds to another party such as a franchisor for payment of royalties. For example, a computer system to which data is provided regarding card sales, e.g., bank card sales, as well as the non-bank card sales of the franchisee within the closeout period, can calculate an amount of funds to be escrowed therefrom or paid therefrom to a payee such as a franchisor. Such computer system can transmit an instruction to the EFP to cause the EFP to transfer the funds to an account of the franchisor, or alternatively, to an escrow account to hold for subsequent payment to the franchisor.

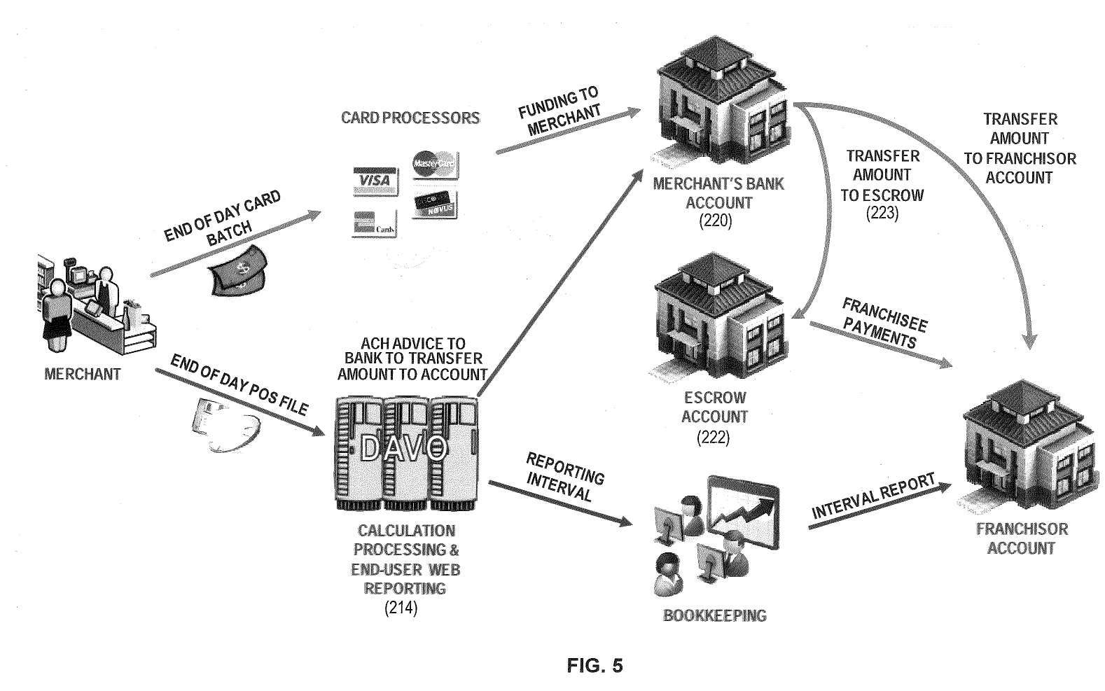

An alternative approach for segregating escrow funds such as for collecting franchise royalties or advertising fees from transactions including cash transactions is illustrated in FIG. 5. As seen therein, the computer system (214) can transmit an instruction, e.g., an ACH advice to transfer funds to an escrow account. In contrast to the method described above relative to FIG. 2, in this case, the computer system (214) transmits the instruction or ACH advice to an institution at which the merchant has an account (220) to transfer an amount (223) therefrom to an account of the franchisor. For example, the computer system (214), after determining an appropriate transfer amount based on the franchisee merchant's transactions during the closeout period, can generate and transmit an EFT request to the seller's bank to direct the transfer of the escrow amount (223) from the franchisee merchant's (220) bank account to the franchisor's account. In one example, the computer system (214) can generate the EFT request to the franchisee merchant's bank using the Automated Clearing House (ACH) network, i.e., in form of an ACH debit request to the institution which holds the franchisee's account.

In a particular embodiment, it may be possible for the computer system (214) to direct funds to be transferred from the franchisee's bank account (220) to an escrow account (222) in the ordinary course of operation when funds are available in the franchisee's account and when there is no other impediment to transferring money from that account. In addition, the computer system (214) can transmit an instruction to direct the EFP to transfer an escrow amount to the escrow account (222) in appropriate circumstances. These activities can be performed, in one example, in a failsafe or backup order, in which the computer system may first seek to transfer a determined escrow amount to the escrow account by one of the above-described techniques such as by transferring from the seller's bank account (FIG. 5), and if such technique does not generate the proper amount of funds, the computer system (214) can seek to transfer the escrow amount or a portion of the escrow amount by another of the techniques such as by the above-mentioned instruction directing the EFP to transfer funds, as seen in FIG. 2.

In one embodiment, a franchise rate can be applied to non-bank card sales, e.g., cash sales and be escrowed, for example, by debiting it from the seller's business checking account and crediting an escrow account in the corresponding amount. For example, if a franchise rate is 10% and cash sales are $100, $10.00 would be debited from the seller's checking account and credited to the escrow account. Note that this implementation for escrowing amounts from non-bank card transactions involving transfers from the seller's bank account could be combined with the above-described method for escrowing amounts from bank card transactions involving EFP transfers. In a particular example, a franchise rate on non-bank card transactions can be escrowed via transfers from the seller's bank account to the escrow account, and a franchise rate on bank card transactions can be escrowed via transfers from the EFP to the escrow account.

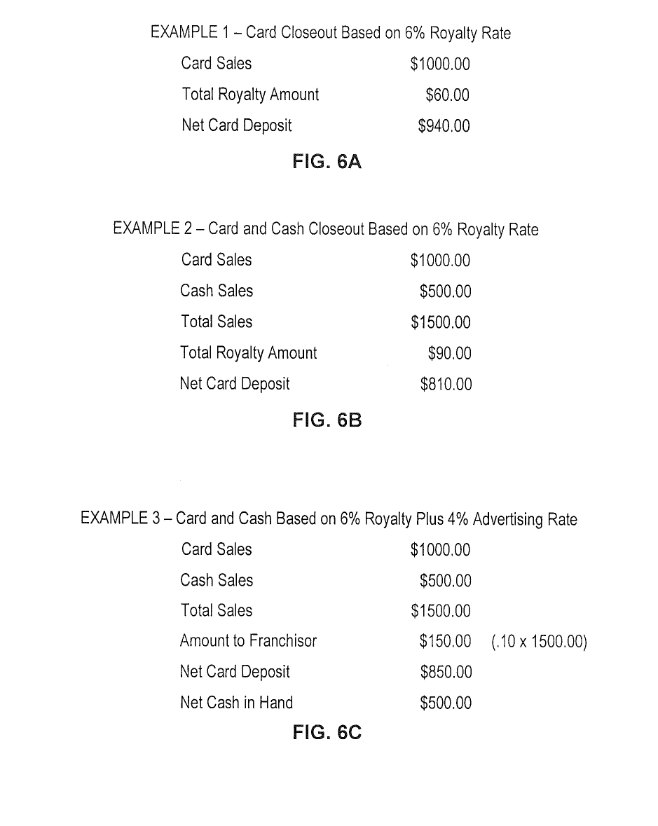

Three examples illustrating escrow transactions at the merchant terminal are illustrated in FIGS. 6A-6C. In FIG. 6A, all reported sales transaction in the closeout period are bank card sales, each owing a 6% franchise rate to the franchisor. Total amount to be transferred to the franchisor, or escrowed for payment can be computer based on the franchise rate and total bank card sales. A net deposit (less franchise payments paid or escrowed) based on an amount of the bank card transactions can be deposited in the franchisee merchant account.

In FIG. 6B, total card sales and total non card sales, e.g., cash or other non-card sales, are each reported for a closeout period, each owing a 6% royalty rate. An amount of card sales is combined with an amount associated with cash and other non-card sales, and a total amount can be computed based on the royalty or other franchise rate and on total sales. A net deposit (less transfer amount paid or amount escrowed representing the franchise rate owed on the combined sales amount) can be deposited in the franchisee merchant's account.

In FIG. 6C, card sales, and cash and other non-card sales totals are reported. Franchise royalty amounts calculated by the sales registry device or POS terminal for respective bank card transactions as well as non-bank card transactions can be totaled to determine an amount to be transferred directly to an account of the franchisor or to be deposited in the escrow account. A net deposit representing an amount of the card sales less the transfer amount or escrow amount and any other applicable fees can then be deposited in the franchisee account. In such example, funds from the non-card sales can remain on hand with the franchisee seller.

In addition to escrowing funds for franchise fees owed on card sales as well as non-card sales, the above-disclosed method may be extended, for example, to sales made via the Internet, or made via mail, telephone or fax (hereinafter, Internet and mail/phone/fax sales). A franchise amount associated with the online transaction and the franchisor can then be determined in accordance with a royalty or other franchise rate applicable to the Internet or mail/phone/fax transaction.

As is further described herein, one example provides a method for collecting other amounts that may be imposed on a franchisee by the franchisor, or otherwise by state and/or federal government agencies. For example, such method may provide for adjusting the rate of franchise royalty or advertising fee payments (or other collection) in order to address back amounts owed. In this manner, a franchisee seller may for example pay the franchisor for back amounts, i.e., arrears, owed at a manageable rate, until the back amounts are repaid. For example, in a case where franchisee owes a franchise royalty rate of 10%, the escrow rate may be adjusted upward (for example, to 16%) in order to collect against back amounts owed. Such method could be applied to virtually any application in which a franchisee seller desires or is otherwise required to effect a withholding of funds collected from bank card sales transactions, and for payment of escrowed merchant funds to any legitimate payee (for example, local, state and federal authorities, judicial authorities, and payees who have received legal judgments against a seller). For example, in addition to the applications previously disclosed, it is contemplated that the method could be applied to generate escrow funds for paying other back amounts owed, e.g., for the franchisor's advertising done on the franchisee's behalf, or for effecting a savings account for seller (in the latter case, the payee of funds escrowed would be the seller).

It is also contemplated that in one embodiment, the present method may be used for the purpose of creating multiple escrow funds simultaneously. For example, the franchisee seller could specify more than one escrow rate each to be applied to one or more classes of eligible sales transactions. The seller in such case may provide advance directives which identify authorities or parties to whom associated escrowed funds are to be disbursed in accordance with applicable rates, or in accordance with escrow rates as specified by the seller. Such directives may then be stored as information, e.g., a template, for use by computer system, e.g., system (14, FIG. 2; or 214, FIG. 5) in performing escrow or payment operations. Based on the stored information, the computer system could then transmit instructions directing the EFP or merchant bank to transfer specific amounts for each closeout period in accordance with the advance directives of the seller and in accordance with a sales amount for at least one transaction during the closeout period. In a particular embodiment, the seller may be given an opportunity to review and approve transfer of specific amounts of funds before such transfers are made.

In any or all of the examples provided herein in which a franchisee seller or other person or entity has an input in directing the transfer of funds, the computer system may provide a secure interface, e.g., requiring authentication, encryption, and possibly a certificate or digital signature, with which the seller or other person or entity can exchange information, or provide an advance directive to the computer system, for example. Thus, when amounts to be escrowed are associated with garnishments, e.g., legal judgments, the secure interface may be accessible by a party other than the seller.

In addition to the above-described ways in which funds can be escrowed for payment of franchise fees, in a particular embodiment, the franchisee seller may select a particular person, business or organization as a payee to whom a portion of the funds collected by an EFP based on the seller's transactions is to be credited. In one such example, a portion of the seller's receipts collected by an EFP for a closeout period can be credited to an account for payment to a lender or other business which extends credit to the seller in some way. In such case, the seller effectively grants the lender or other business a right to a portion of its accounts receivables, which that lender or business can then receive via fund transfers made by the EFP out of the seller's incoming bank card payment stream. The fund transfers can be fixed or variable amounts, or a variable amount with a fixed floor amount, fixed ceiling amount, or both, and in particular cases the amounts may be calculated as a percentage of the bank card receipts for the closeout period. As in the above examples, the parties may alternatively agree to calculate amounts to transfer to the lender which are based on the total receipts of the seller for both bank card and non-bank card transactions, even though the amounts actually transferred to the lender may come entirely out of the bank card receipts in an example similar to the process which is described above relative to FIG. 2.

Thus, in a particular example, a restaurant may receive food on credit from a wholesaler with an agreement for the wholesaler to receive up to 10% of the restaurant's daily bank card and non-bank card receipts in payment for the food. In some cases, the wholesaler can be the same as the franchisor. In such case, an advance directive can be provided to the computer system (14, FIG. 2; or 214, FIG. 5) to implement this payment agreement between the restaurant and the wholesaler in addition to the franchise fees that are paid to the franchisor based on the franchisee seller's receipts. At the end of each day (or other closeout period) computer system (14 or 214), in turn, can issue instructions to an EFP, similar to the above-described example of FIG. 2, or to an institution at which the franchisee seller (the restaurant business) banks, similar to the above-described example of FIG. 5, to transfer a certain amount of funds to an escrow account, which can be calculated by the computer system relative to the total bank card and non-bank card receipts of the restaurant for the day, or other closeout period.

In a particular example, the computer system may store information relating to a payee, e.g., the wholesaler in the restaurant example, such that the computer system (14, 214) can instruct the EFP, or alternatively the institution at which the franchisee seller has a deposit account, to transfer funds directly to an account of the payee as a fixed or variable portion of the bank card sales of the seller during the closeout period.

In a further example, the method may further include a function to provide information about escrowed funds to the franchisee seller. As described herein, escrow account information can be provided at the seller terminal at the time of a close out in a form, for example, similar to the sales draft created by a sales registry device, e.g., POS terminal in response to each sales transaction. In addition, the method may additionally involve use of escrow account management software which can be periodically used by an escrow agent, for example, to report a summary to the seller for a reporting interval, and/or to prepare a report for reconciling the seller's receipts and franchise fees escrowed or collected for the reporting interval. If one or more types of funds are being escrowed or collected, the monthly summary to the seller may for example report the following information for each type: a) escrow funds collected over a current closeout period, and cumulatively for a designated number of prior closeout periods, b) funds paid or escrowed for a current payment period and cumulatively for a designated number of prior payment periods, and c) balance of funds owed (if the fund type relates, for example, to back amounts owed or other obligations not relieved in a single payment period).

An escrow agent may for example provide a secure web site for presenting escrow account information to the seller and/or other payees (for example, the franchisor). Alternatively, an escrow agent may physically or electronically transmit (for example, by e-mail, facsimile or other e-commerce means) escrow account information on a periodic basis directly to the seller and/or payee.

Summarizing, an advantage of the method and system according to an embodiment of the invention is that based on a franchisee's receipts an appropriate amount can be transferred to an escrow account for payment to a franchisor or alternatively, paid to the franchisor without being transferred to an escrow account first. When amounts are deposited in an escrow account, an appropriate amount can then be paid from an escrow account to the franchisor at an interval, for example, daily, weekly, monthly or quarterly or at any other interval, for example, at multiple times during a day, in a way that can be done accurately and with relatively little or no intervention on the part of the seller.

Many present EFT systems provide effective security, for example such as encryption, as for moving money between accounts. The disclosed method may also operate with a secure web-based account available to the seller that enables the seller to check the status of the seller's account with the escrow agent. In addition, as an alternative to the reporting of the non-bank card transactions by the seller or merchant, a web-based account may be provided to allow communications from the franchisee to the computer system with regard to such transactions.

The method may also be applied to extract a service fee applied by the EFP. The method may further involve one or more of the following:

directing an electronic processor of funds (EFP) associated with an online transaction to withhold an amount owed from the transaction for payment to a franchisor;

directing an electronic processor of funds (EFP) associated with the online transaction to credit an escrow account with the amount withheld; or

directing an institution to withdraw a second amount from an account of the franchisee for payment to the franchisor.

In a particular example, the amount withheld can be determined in accordance with a sale amount of an online transaction.

In a particular example, a franchise fee can comprise a first fee based on a franchise royalty rate owed to the franchisor and a second fee based on a franchise advertising rate owed to the franchisor, and the step of determining can include determining the first fee based on the franchise royalty rate and the second fee based on the franchise advertising rate.

The disclosed method may also be used by businesses, particularly small businesses, to provide a forced savings plan. Many small businesses are S corporations with profits flowing through to the officers as income. To boost this income the computer system can direct the transfer of funds from an EFP or financial institution into a savings account for such business. Many small businesses welcome ways to help save small amounts of money over time, a proven method of saving money. If the EFP offered the disclosed service to deduct an allocatable percentage from each transaction and funnel it, for example, into a bank-managed savings account digitally for the business, such business can save up money automatically.

A variety of service providers may be selected to serve in the roles of EFP and escrow agent (for example, First Data Corporation, Telecheck, Chase Paymentech, and dozens of others).

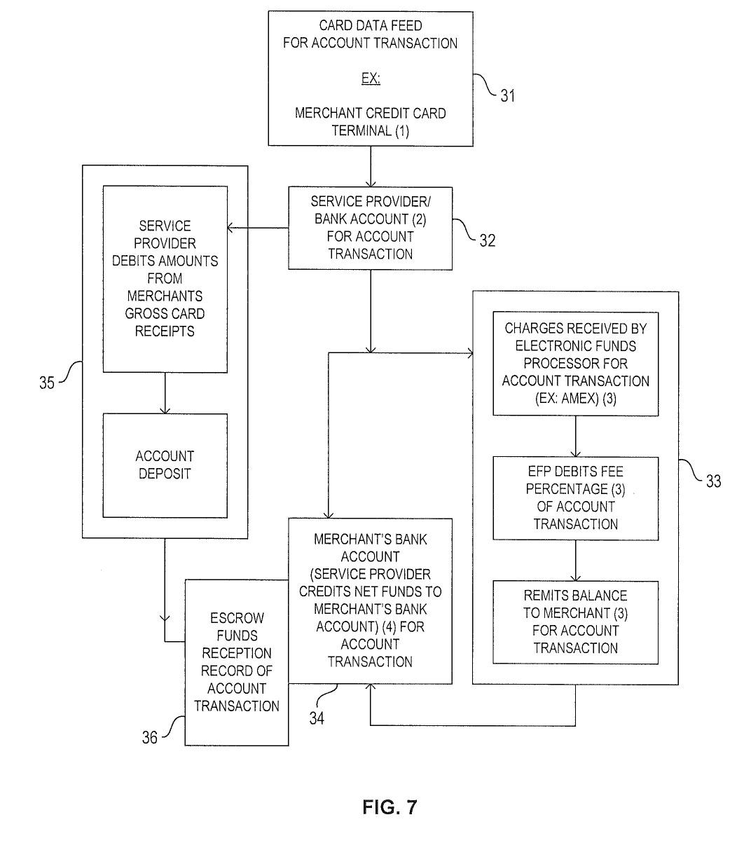

FIG. 7 provides another view of the disclosed method.

A bank card and data feed as shown in box 31 interlinks with a bank network (EFP) as shown in box 32. Charges, i.e., transaction funds are received by the EFP as shown in box 33. The EFP debits a fee percentage, and remits the balance to the franchisee merchant's bank account, as shown in box 34. At the same time, the EFP debits an allocated franchise fee for a retailer's gross card receipts, e.g., bank card receipts, and may make an escrow account deposit to the escrow account as shown in box 35.

Several pricing models may be used to derive revenues from escrow account services and functionality provided, if used. A first approach is for a computer system (e.g., computer system (14) of FIG. 2) which directs the EFP and/or escrow agent to escrow funds, to charge based on a percentage figure of the overall value of escrow account transactions. A second method is for the computer system to charge a flat fee for every escrow account transaction regardless of dollar amount. A third approach is for the computer system to charge a transactional fee based upon the volume of escrow account transactions processed.

As these and other variations and combinations of the features discussed above can be utilized without departing from the present invention as defined by the claims, the foregoing description of the preferred embodiments should be taken by way of illustration rather than by way of limitation of the invention as defined by the claims.

1. A computer-implemented method performed by at least one computer system, the method comprising:
(a) determining a sales amount corresponding to one or more transactions of a franchisee associated with a closeout period;
(b) determining a transfer amount based on the sales amount and at least one franchise rate applicable to the one or more transactions; and
(c) transmitting an instruction to an electronic funds processor (EFP) directing the EFP to credit an account with the transfer amount when the sales amount equals or exceeds the transfer amount.

2. The method of claim 1, wherein step (a) includes determining a first sales amount associated with one or more non-bank card transactions during the closeout period,
determining a second sales amount associated with one or more bank card transactions during the closeout period,
and step (c) includes transmitting an instruction to the EFP directing the EFP to credit the account with the transfer amount when the second sales amount at least equals the transfer amount.

3. The method of claim 2, wherein step (a) includes determining the first and second sales amounts using information associated with the closeout period transmitted from at least one sales registry device.

4. The method of claim 1, wherein the account is an account associated with the franchisor.

5. The method of claim 1, wherein the account is an escrow account, and the method further comprises transmitting an instruction to an institution associated with the escrow account to direct the institution to credit an account associated with a franchisor with a second amount.

6. The method of claim 5, wherein the second amount equals or exceeds the transfer amount.

7. The method of claim 1, further comprising:
determining an interval sales amount based on a sum of sales amounts corresponding to each of a plurality of closeout periods within a reporting interval, the determining performed using information representing the sales amount in each corresponding closeout period;
determining a franchisee interval amount based on the interval sales amount and the franchise rate;
determining a sum of the transfer amounts credited to the account based on the reporting interval; and
determining whether an amount is owed by the franchisee based on comparing the franchisee interval amount with the sum of the transfer amounts corresponding to each of the plurality of closeout periods.

8. A computer-implemented method performed by at least one computer system, the method comprising:
(a) determining a sales amount corresponding to one or more transactions of a franchisee associated with a closeout period;
(b) determining a transfer amount based on the sales amount and at least one franchise rate applicable to the one or more transactions; and
(c) transmitting an instruction to a financial institution directing the financial institution to debit the transfer amount from an account associated with the franchisee and to credit a second account with the transfer amount when the sales amount equals or exceeds the transfer amount.

9. The method of claim 8, wherein step (a) includes determining a first sales amount associated with one or more non-bank card transactions during the closeout period,
determining a second sales amount associated with one or more bank card transactions during the closeout period,
and step (c) includes transmitting an instruction to the EFP directing the EFP to credit the account with the transfer amount when the second sales amount at least equals the transfer amount.

10. The method of claim 9, wherein step (a) includes determining the first and second sales amounts using information associated with the closeout period transmitted from at least one sales registry device.

11. The method of claim 8, wherein the account is an escrow account, and the method further comprises transmitting an instruction to an institution associated with the escrow account to direct the institution to credit an account associated with a franchisor with a second amount.

12. The method of claim 11, wherein the second amount equals or exceeds the transfer amount.

13. The method of claim 8, further comprising:
determining an interval sales amount based on a sum of sales amounts corresponding to each of a plurality of closeout periods within a reporting interval, the determining performed using information representing the sales amount in each corresponding closeout period;
determining a franchisee interval amount based on the interval sales amount and the franchise rate;
determining a sum of the transfer amounts credited to the account based on the reporting interval; and
determining whether an amount is owed by the franchisee based on comparing the franchisee interval amount with the sum of the transfer amounts corresponding to each of the plurality of closeout periods.

14. The method of claim 8, wherein the step of determining the transfer amount determines the transfer amount as an amount selected from, or the sum of two or more amounts selected from the group consisting of:
(i) an amount estimated to pay a predetermined sum from one or more of the first and second sales amounts over a predetermined number of closeout periods, wherein the estimated amount can be fixed or can vary during the predetermined number of closeout periods,
(ii) an amount being the predetermined percentage multiplied by one or more of the first and second sales amounts, or
(iii) an amount being a sum of the predetermined percentage multiplied by at least one of the first and second sales amounts,
wherein said predetermined percentage comprises at least one of:
(i) the franchise rate, or
(ii) an estimate for paying the predetermined sum from the one or more of the first and second sales amounts over a predetermined number of sales periods.

15. A system for segregating funds associated with transactions of a franchisee to provide a source of funds available for payment of fees associated with a franchise, comprising:
a computer system; and
instructions executable by the computer system to perform a method comprising:
(a) determining a sales amount corresponding to one or more transactions of a franchisee associated with a closeout period;
(b) determining a transfer amount based on the sales amount and at least one franchise rate applicable to the one or more transactions; and
(c) transmitting an instruction to an electronic funds processor (EFP) directing the EFP to credit an account with the transfer amount when the sales amount equals or exceeds the transfer amount.

16. The system of claim 15, wherein step (a) includes determining a first sales amount associated with one or more non-bank card transactions during the closeout period,
determining a second sales amount associated with one or more bank card transactions during the closeout period,
and step (c) includes transmitting an instruction to the EFP directing the EFP to credit the account with the transfer amount when the second sales amount at least equals the transfer amount.

17. The system of claim 15, wherein step (a) includes determining the first and second sales amounts using information associated with the closeout period transmitted from at least one sales registry device.

18. The system of claim 15, wherein the account is an account associated with the franchisor.

19. The system of claim 15, wherein the account is an escrow account, and the method further comprises transmitting an instruction to an institution associated with the escrow account to direct the institution to credit an account associated with a franchisor with a second amount.

20. The system of claim 19, wherein the second amount equals or exceeds the transfer amount.

21. The system of claim 15, further comprising:
determining an interval sales amount based on a sum of sales amounts corresponding to each of a plurality of closeout periods within a reporting interval, the determining performed using information representing the sales amount in each corresponding closeout period;
determining a franchisee interval amount based on the interval sales amount and the franchise rate;
determining a sum of the transfer amounts credited to the account based on the reporting interval; and
determining whether an amount is owed by the franchisee based on comparing the franchisee interval amount with the sum of the transfer amounts corresponding to each of the plurality of closeout periods.

22. A tangible storage medium having computer-readable instructions recorded thereon, the instructions being executable by a computer system to perform a method, the method comprising:
(a) determining a sales amount corresponding to one or more transactions of a franchisee associated with a closeout period;
(b) determining a transfer amount based on the sales amount and at least one franchise rate applicable to the one or more transactions; and
(c) transmitting an instruction to a financial institution directing the financial institution to debit the transfer amount from an account associated with the franchisee and to credit a second account with the transfer amount when the sales amount equals or exceeds the transfer amount.

23. The tangible storage medium of claim 22, wherein step (a) includes determining a first sales amount associated with one or more non-bank card transactions during the closeout period,
determining a second sales amount associated with one or more bank card transactions during the closeout period,
and step (c) includes transmitting an instruction to the EFP directing the EFP to credit the account with the transfer amount when the second sales amount at least equals the transfer amount.

24. The tangible storage medium of claim 23, wherein step (a) includes determining the first and second sales amounts using information associated with the closeout period transmitted from at least one sales registry device.

25. The tangible storage medium of claim 22, wherein the account is an escrow account, and the method further comprises transmitting an instruction to an institution associated with the escrow account to direct the institution to credit an account associated with a franchisor with a second amount.

26. The tangible storage medium of claim 25, wherein the second amount equals or exceeds the transfer amount.

27. The tangible storage medium of claim 22, further comprising:
determining an interval sales amount based on a sum of sales amounts corresponding to each of a plurality of closeout periods within a reporting interval, the determining performed using information representing the sales amount in each corresponding closeout period;
determining a franchisee interval amount based on the interval sales amount and the franchise rate;
determining a sum of the transfer amounts credited to the account based on the reporting interval; and
determining whether an amount is owed by the franchisee based on comparing the franchisee interval amount with the sum of the transfer amounts corresponding to each of the plurality of closeout periods.

28. The tangible storage medium of claim 22, wherein the step of determining the transfer amount determines the transfer amount as an amount selected from, or the sum of two or more amounts selected from the group consisting of:
(i) an amount estimated to pay a predetermined sum from one or more of the first and second sales amounts over a predetermined number of closeout periods, wherein the estimated amount can be fixed or can vary during the predetermined number of closeout periods,
(ii) an amount being the predetermined percentage multiplied by one or more of the first and second sales amounts, or
(iii) an amount being a sum of the predetermined percentage multiplied by at least one of the first and second sales amounts,
wherein said predetermined percentage comprises at least one of:
(i) the franchise rate, or
(ii) an estimate for paying the predetermined sum from the one or more of the first and second sales amounts over a predetermined number of sales periods.
